(19) United States
(12) Patent Application Publication
(10) Pub. No.: US 2023/0195743 A1
(43) Pub. Date: Jun. 22, 2023

(54) BALANCING TIME-CONSTRAINED DATA TRANSFORMATION WORKFLOWS

(71) Applicant: Zendesk, Inc., San Francisco, CA (US)

(72) Inventor: Kostiantyn Demchuk, Dublin (IE)

(73) Assignee: Zendesk, Inc., San Francisco, CA (US)

(21) Appl. No.: 17/559,267

(22) Filed: Dec. 22, 2021

(51) Int. Cl. G06F 16/25; G06F 16/28

(52) U.S. Cl. CPC G06F 16/254; G06F 16/285

(57) ABSTRACT

Systems and methods are provided for balancing the execution of data transformation workflows within one or more ETL (Extract, Transform, Load) pipelines to promote their completion within a time constraint. On a periodic basis, data from multiple applications hosted by an organization are collected and segregated by associated providers, sponsors, brands, or other entities that correspond to different contexts in which end users (e.g., customers of the providers or other entities) use the applications. The providers are classified based on a selected characteristic of their data (e.g., amount of data, number of customers, number of customer support tickets). Datasets of multiple providers are batched within and/or across classes; the number of datasets batched is selected so as to allow all datasets to be transformed within the time constraint. Batched datasets are submitted to computing clusters to perform the data transformations to make the data consumable (e.g., viewable) by the providers.

### BACKGROUND

This disclosure relates to the field of computer systems. More particularly, a system and methods are provided for balancing the execution of data transformation workflows within time-sensitive or time-constrained ETL (Extract, Transform, Load) pipelines.

Online applications and services generate tremendous amounts of data reflecting end users' activities. The raw data captures and represents those activities but usually is not suitable for direct consumption by human administrators of the applications and services, or by entities that make the applications and services available to their end users. Instead, the raw data must be processed in some manner, through an ETL pipeline for example, in order to place it in a form or forms that can be readily visualized and/or manipulated by humans.

Depending on the amount of data produced by a given application or service, and the number of applications and services for which data must be processed by a given data center or organization, the amount of time needed to process all data through an ETL pipeline may vary dramatically. This makes it very difficult to perform capacity planning and may cause the data center or organization to allocate or dedicate too many resources (e.g., computer processors, data storage), some of which end up being unused or underutilized.

In addition, some organizations may be time sensitive or be subject to time constraints regarding the transformation of raw data into usable data. Unfortunately, existing methods of and products for conducting data through an ETL pipeline do not provide much assistance in completing the process within a particular period of time, especially in a complex environment involving many applications, services, end users, and/or other criteria that complicate the process.

### SUMMARY

In some embodiments, systems and methods are provided for balancing data transformation workflows to satisfy applicable time constraints while conserving computing resources, and involve classifying segregated sets of data so that they can be processed within the time constraints.

In these embodiments, an organization hosts multiple applications (and/or services) for access by end users within contexts associated with different provider entities. Illustratively, some providers may be vendors of goods and/or services, and may sponsor, subscribe to, or otherwise make the applications available to their customers. Illustrative applications include programs for supporting sales, customer support, chat (e.g., with an agent or representative of a provider), and so on. Thus, a plethora of end users may access the applications within various contexts associated with different providers. During their access, the applications generate tremendous quantities of data representing or reflecting the end users' activity, some or all of which must be processed through one or more ETL (Extract, Transform, Load) pipelines.

On a periodic or recurring basis, the organization retrieves or extracts the applications' data in a manner that segregates each provider's corresponding data. Data for a given provider across all applications used by the provider's end users are aggregated into sets of data associated with the provider (e.g., each application yields at least one subset of the provider's dataset). Based on some characteristic of the provider and/or the provider's data, the provider is classified within one of multiple predetermined classes or classifications. Illustrative characteristics include amount of data, number of customers, number of end user sessions, number of end user customer support tickets, number of applications the provider subscribes to, and frequency with which the data are to be processed (e.g., hourly, daily, weekly).

Within each class, multiple providers are grouped into individual batches. The number of providers batched together may vary over time, but is selected so as to facilitate execution of a data transformation process upon the batched datasets within a specified time period (e.g., one hour). In some implementations, however, a batch may include providers from different classes as long as the batch is estimated to complete within the time period.

In an embodiment in which providers are classified according to the amount of data to be transformed for the provider, batches formed in classes corresponding to providers having relatively large amounts of data may contain relatively few providers' datasets (e.g., one, two, three), while batches formed in classes corresponding to providers having relatively small amounts of data may contain more (e.g., tens of datasets). In an alternative embodiment in which providers are classified based on how long the transformation of their data is expected to take, similar batching may be performed such that batches containing datasets expected to require longer processing times will contain fewer providers' datasets.

After the batches are formed, they are balanced among an available collection of computing clusters (e.g., Amazon® EMR clusters) such that roughly equivalent numbers of batches from each class are distributed to each cluster. Transformed data are subsequently made available to the provider entities via a visualization application and/or other means.

In some embodiments, providers or their datasets are reclassified every time their application data are processed via an ETL pipeline, based on the applicable characteristic (e.g., amount of data, estimated processing time). In other embodiments, providers and/or their datasets may be reclassified on a periodic basis, at which time the classifications are saved and used until it is again time to reclassify them.

In further embodiments, different characteristics or criteria are used or considered for use in classifying providers and/or their datasets. For example, if the amount of data to be transformed for the providers is found to correlate poorly with the durations of time required to transform the data, some other characteristic of the providers or their data may be considered. A machine-learning model may be configured to attempt to correlate the characteristic against historical data and the other characteristic may be adopted if it is found to correlate well with the amount of time needed to process or transform the providers' data.

### DESCRIPTION OF THE FIGURES

FIG. 1 is a block diagram depicting an environment in which data transformation workflows are classified and balanced to facilitate processing within applicable time constraints, in accordance with some embodiments.

FIG. 2 is a flow chart illustrating a method of balancing data transformation workflows to facilitate their processing within applicable time constraints, in accordance with some embodiments.

FIG. 3 is a flow chart illustrating a method of classifying sets of data to be processed in time-constrained data transformation workflows, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system and method are provided for balancing data transformation workflows to conserve computing resources and to satisfy applicable time constraints for the transformation, if any exist. The system and methods may also involve intelligently classifying segregated sets of data included in the workflows to facilitate the combination of different datasets for processing in parallel or in sequence.

In these embodiments, a tremendous amount of raw data is processed through one or more ETL (Extract, Transform, Load) pipelines to convert the data into a form or forms that can be visualized or otherwise consumed or manipulated by a human. However, the raw data is not monolithic or homogeneous in nature, meaning that the entire set of data cannot simply be partitioned or otherwise divided into predetermined chunks that can be ingested through an ETL process.

Monolithic or homogeneous data, in this sense, may be illustratively produced by a single application benefiting a single organization or entity. For example, an organization that maintains a website to sell goods (or provide services) may collect and process data produced during end users' visits to the site to better understand their sales, user requests, complaints, etc.

Instead, in embodiments described herein, an organization hosts multiple applications (and/or online services) for supporting multiple providers (e.g., providers or vendors of goods and/or services), and therefore produces heterogeneous data. Each provider may correspond to a different organization (or set of organizations) that offers a different set of goods and/or services to end users. Thus, providers may include businesses, governmental entities, non-profit organizations, etc.

Each application supports any number of providers by providing functionality such as (but not limited to) sales, inventory, invoicing, support (or helpdesk), chat (e.g., with an agent), social media, surveys, etc. Therefore, data generated within the organization's data center(s) that host the applications not only includes different types of data (e.g., from different applications), but also data associated with different providers. Each application access by an end user is associated with at least one particular provider, which may be considered the ‘context’ within which the end user uses the application. Different providers' data must necessarily be segregated so that a given provider's data is not reported to a different provider.

Time constraints on the processing of raw data may be associated with a regularity with which given providers' data must or should be processed and delivered to the individual providers. For example, some providers may require that new data should or must be made available within some period of time (e.g., 30 minutes, 1 hour, 2 hours). Such constraints may be memorialized in the providers' service level agreements (SLA) that the organization that hosts the applications and that executes the ETL process strives to satisfy.

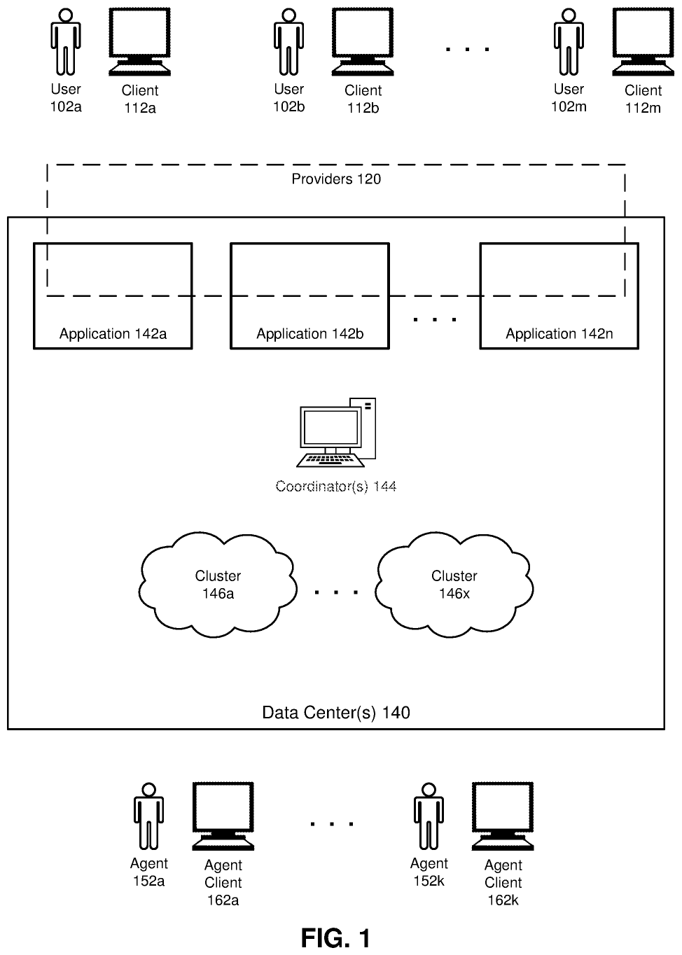

FIG. 1 is a block diagram depicting an illustrative environment in which data transformation workflows are classified and balanced to facilitate processing within applicable time constraints, in accordance with some embodiments.

In the environment of FIG. 1, an organization that provides applications for use by multiple providers and multiple end users operates one or more data centers 140. Each data center 140 hosts applications 142a-142n, each of which is used (e.g., subscribed to) by any number of providers 120 to interact with end users 102a-102m, which access the applications via clients 112a-112m. Agents 152a-152k are available to assist end users 102 via agent clients 162a-162k.

End user clients 112 are coupled to data center 140 and access the physical and/or virtual computers that host the applications via any number and type of communication links. For example, some clients 112 may execute installed software for accessing any or all applications; this software may be supplied by providers 120 and/or data center 140. Other clients 112 may execute browser software that communicates with web servers that are associated with and/or host applications 142. The web servers may be operated by data center 140 and/or individual providers.

In some implementations, a client 112 may access data center 140 and applications 142 directly (e.g., via one or more networks such as the Internet); in other implementations, a client 112 may first connect to a provider 120 (e.g., a website associated with a particular provider) and be redirected to data center 140 and an application 142. In yet other implementations, one or more applications 142 may execute upon computer systems operated by a provider 120, in which case application data are reported to or retrieved by data center 140.

End users 102 use applications 142 in the context of particular providers. In other words, each user session with an application is associated with at least one provider 120. The context may be set when an end user is redirected to data center 140 from the corresponding provider's site, when the end user logs in using credentials provided by the provider, or in some other way.

Coordinator(s) 144 are physical and/or virtual computers that manage or assist the execution of data transformation workflows on computer clusters 146 (e.g., clusters 146a-146x). Coordinator 144 may therefore collect application data (or manage the collection of such data) for transformation within clusters 146, batch multiple sets of data (e.g., corresponding to different providers) for execution within a cluster 146, balance the batches among workflows submitted to the clusters, classify or categorize providers to assist the batching, and/or perform other actions. For example, a coordinator 144 may identify capacities of clusters 146 and use the information to set upper bounds on resource allocations, maintain queues of providers or batched datasets for submission to the clusters, monitor clusters' performances, etc.

For example, to classify providers and/or their datasets, a coordinator may execute a machine learning module that consumes historical data and correlates (or attempts to correlate) the amount of time needed to transform a batch or set of data (e.g., by processing it through an ETL pipeline) with one or more characteristics of the data, the provider(s) associated with the data, the application(s) that produced the data, and/or other characteristics. When a correlation is found, the coordinator may subsequently use the correlation to estimate how much time will be needed to transform a given set of data from a provider, or a batch of datasets from different providers. This information may be used to classify a provider, dataset, or other entity, as described further below.

Clusters 146, in some embodiments, are cloud-based collections of computing resources. For example, a cluster may comprise a Spark cluster hosted by AWS® (Amazon Web Services®) or, more specifically, an Amazon® EMR (Elastic MapReduce) runtime environment. Sets of provider data gleaned from the multiple applications 142, within batches comprising multiple provider datasets, are submitted to clusters 146, which execute the necessary ETL operations to transform the data from a raw form to a form or forms that can be used by humans and/or computing devices.

Because providers' end user/customer bases tend to grow over time, the organization's applications will naturally encounter more and more end users and produce more and more data. Therefore, unless applicable time constraints are loosened, which rarely occurs, the organization must strive to schedule data transformation workflows intelligently so that the terms of each provider's SLA remain satisfied. In an illustrative embodiment, data center 140 hosts tens of distinct applications for use by tens of thousands of providers (e.g., 20,000; 30,000; 40,000) and millions of end users.

Classification of providers' data from applications 142, as mentioned above and described below, allows coordinator 144 to batch together multiple sets of data from different providers for execution as a single job within a cluster 146. More particularly, in an illustrative embodiment, providers and/or individual provider datasets are classified within a range of sizes such as XXS (extra extra small), XS (extra small), S (small), M (medium), L (large), XL (extra large), XXL (extra extra large), etc. Providers whose data are expected to take the longest periods of time to transform are assigned to the largest-sized categories while providers whose data are expected to take the shortest periods of time are assigned to the smallest-sized categories. As stated above, in some embodiments machine learning is used to predict the amount of time needed to transform a set of data.

In an illustrative implementation, providers whose datasets are expected to require more than 90 minutes to be transformed are classified XXL and run in isolation, meaning that they are not batched with any other providers' datasets. Providers with processing estimates of 60-90 minutes and 45-60 minutes are classified XL and L, respectively. XL providers are batched in pairs, while up to 5 L providers may be batched together.

Providers estimated to require 30-45 minutes and 25-30 minutes are classified M and S respectively. Up to 12 M providers and up to 30 S providers may be placed in one batch. XS and XXS providers are estimated to require 15-25 minutes and 0-15 minutes, respectively. Up to 75 XS providers and 200 XXS providers may be batched together as one job.

In some alternative embodiments, instead of classifying providers or their datasets and subsequently batching their datasets based on the classifications, the datasets may be batched first and then classified as a batch. In these embodiments, after providers' data are extracted from the applications (into individual datasets associated with the providers), multiple providers' corresponding datasets are grouped and some aspect of the combined data (e.g., total data size, estimated amount of time for transforming the combined data) is used to classify the grouped data. Multiple groups of data may then be scheduled for data transformation similar to or in the same manner in which batches of provider datasets within predetermined classes are scheduled for transformation, as described herein.

Further, in these alternative embodiments, different schemes may be used to perform the grouping, and groupings that are deemed inefficient may be abandoned in favor of other groupings. A grouping may be deemed inefficient if it would require too much time to transform (e.g., because it contains too much data), because it does not contain enough data to sufficiently utilize cluster resources, and/or for other reasons. Thus, besides being formed randomly, groupings may be generated using virtually any search or selection algorithm—to combine providers whose data are similar in complexity and/or quantity, to combine providers whose data differ in complexity and/or quantity, to combine providers in the order in which their data are extracted, etc. A machine learning model may be used to test different strategies and identify one or more that are most effective.

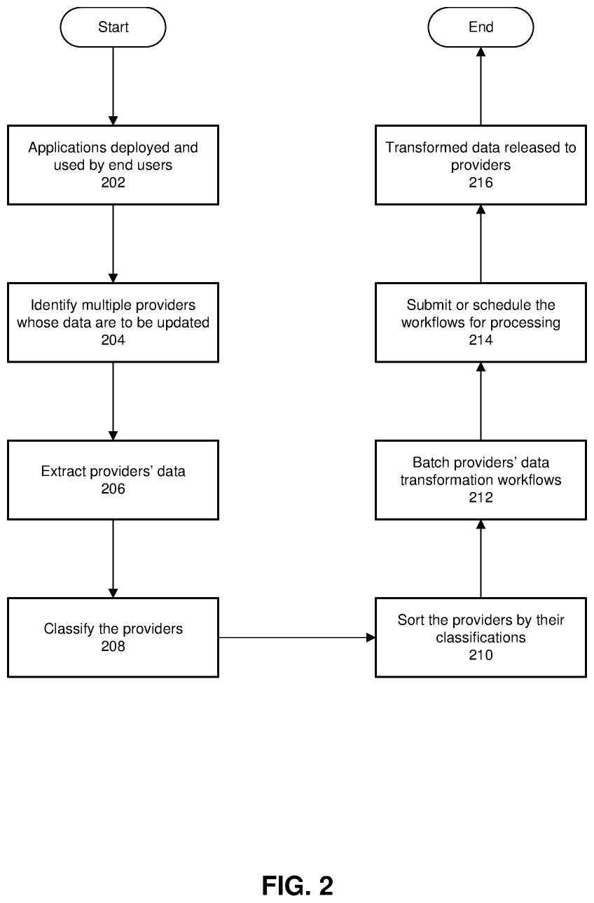

FIG. 2 is a flow chart illustrating a method of balancing data transformation workflows to facilitate their processing within applicable time constraints, in accordance with some embodiments. One or more of the operations may be omitted, repeated, and/or performed in a different order. Accordingly, the specific arrangement of steps shown in FIG. 2 should not be construed in a manner that limits the scope of the embodiments.

In these embodiments, a workflow corresponds to a batch of one or more datasets corresponding to individual providers' sets of data extracted from one or more applications or services (e.g., applications 142 of FIG. 1). Workflows are submitted for execution by one or more collections of computing resources (e.g., clusters 146 of FIG. 1) configured with hardware and software for transforming the data according to an applicable ETL pipeline. Multiple workflows may execute simultaneously on different collections of resources, and sets of data within a given workflow may be processed in parallel and/or in series.

In operation 202, end users of the applications/services research and/or make purchases from providers, pay for their purchases, seek and receive support (e.g., technical support, billing support), chat with an agent, and/or employ other functionality of the applications, all within the context of various providers. These activities cause new and/or updated data to be saved to memorialize a new transaction, record an interaction between an end user and an agent or representative of a provider, update a customer support ticket, etc. In particular, each data point or record generated or updated by an application is associated with one of the multiple providers and the end user or users that triggered the data.

End user activity with the applications, and creation and modification of application data continues throughout the illustrated method. A goal of the method is to regularly process the raw data so as to make it available to the providers or representatives of the providers within applicable time constraints, if there are any.

In operation 204, a coordinator entity (e.g., coordinator 144 of FIG. 1) identifies multiple providers whose data are to be transformed in order to satisfy time constraints associated with the providers and/or to meet a processing schedule for providing updated data to the providers. For example, for providers whose SLAs specify that they are to be able to access updated data within one hour of the creation or modification of the corresponding raw data, the coordinator may automatically initiate the ETL pipeline and transformation process on their raw data on an hourly basis. Depending on the operating environment, tens of thousands of providers may be identified for periodic, regular, or recurring processing.

In operation 206, the coordinator extracts the identified providers' data from all applications to which the providers subscribe (e.g., from data stores used by the applications). In particular, the coordinator will obtain the delta for each application, which encompasses all changes to the providers' data across all applications since the last time the providers' data were retrieved.

Each identified provider's data is extracted, and the amount of data extracted will usually differ from provider to provider and from application to application, and also from one periodic processing to another. For example, each time data are gathered for processing, each identified provider's portion of the data is copied or extracted from data structures used by each application (e.g., tables, lists, blobs) and segregated from other providers' data. Amounts of data may be measured or estimated on a per-provider basis. Some applications may possess no data for a provider, which may indicate that the provider does not use or subscribe to those applications, or does not make them available to its end users or customers.

The total amount of data extracted for a given provider (or some other relevant value) may be assigned as a weight (e.g., measured in GB, MB, KB, etc.). As one alternative, a provider's total amount of extracted data may be used to assign a weight that constitutes an estimate of how long it will take a cluster to transform the data. For example, based on historical data (e.g., averages of many previous data transformation workflows, a regression executed upon past data), a collection of provider data of a particular amount may be expected to take 25 minutes to transform, in which case a weight of 25 may be assigned to the dataset.

As another alternative, a weight assigned to a given provider's dataset may correspond to an ‘impact’ value defined as k₁*tickets+k₂*end user count, wherein tickets is the number of customer support tickets for the provider submitted by its end users (e.g., for all time, since the last data transformation, for some other time period) and end user count is the number of unique end users for the provider (e.g., for the same time period as tickets). Variables k₁ and k₂ are weights assigned by a machine learning module that is trained and/or tested on historical data. Other terms may be added to the equation.

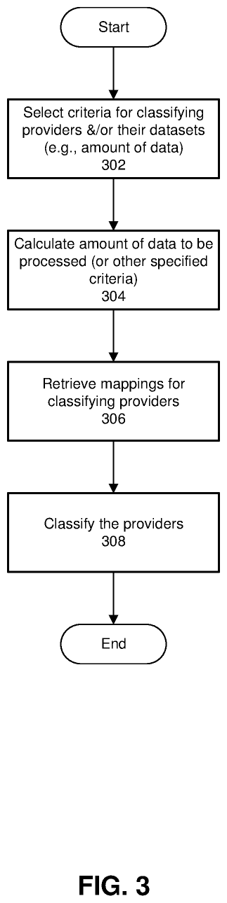

In operation 208, the coordinator retrieves classifications or labels for each identified provider or, alternatively, determines appropriate classifications in real-time immediately after assembling the providers' datasets or while the datasets are assembled (e.g., by using the weights assigned to their datasets). A method of determining providers' appropriate classifications in real-time is described below in conjunction with FIG. 3. Each provider's most recently determined or computed classification is stored, and may change with any frequency. Thus, in the method of FIG. 2, the coordinator simply retrieves and applies classifications that were previously determined and saved.

In operation 210, the coordinator sorts the identified providers by their assigned classes and determines how many providers belong to each class (e.g., XXS to XXL). Providers may also be sorted or further sorted within each class, by weights assigned to their datasets, for example.

In operation 212, within each classification the coordinator forms one or more batches of the providers' datasets to create data transformation workflows that are estimated to complete within the applicable time constraint (e.g., 30 minutes, 1 hour). As described above, the maximum number of provider datasets that can be batched together may differ from one implementation to another depending on the time constraint, the amount of data to be transformed, the number of computing clusters available to perform the transformation, and/or other factors.

In some implementations, when batches are formed from datasets of providers within a given class (e.g., XS, M, XXL), an attempt is made to balance them. For example, the batches may be uniformly or similarly limited in terms of the number of datasets they may contain and/or the total sum of weights of the included datasets. Therefore, the datasets may first be sorted into a list according to their size (e.g., amounts of data) or assigned weights. Then, one batch after another is populated by alternatingly selecting datasets from each end of the list until either limit is reached.

More specifically, for each batch, the dataset with the lowest (or highest) weight may be the first one removed from the list and added to the batch. Then the dataset with the highest (or lowest) weight may be removed from the list and added to the batch, and so on until either limit is reached or approached. A final batch that does not approach either limit may be augmented with datasets from a lower classification. A result of this MinMax manner of populating batches is that all batches within a given category may be very similar in terms of how long their transformation workflows will take to execute.

The limits on a batch's population may differ from class to class, such that higher classes can include higher maximum total weights and lower classes can include greater numbers of providers, for example. An illustrative class (e.g., the L class described above) may be limited to a maximum of 5 providers and/or a total weight of approximately 260 (where the weight corresponds to the estimated time needed to transform the batched data). Effective or optimal limits may be identified by a machine learning model trained on past datasets and data transformation results.

For example, in some alternative implementations, instead of summing the weights of batched datasets and directly comparing the sum to a maximum total weight, an additional (e.g., batch) weight may be employed, which may differ from one classification's batches to another's. In these alternative implementations, the weight-related limit of a batch is equal to k*total weight, where total weight is the sum of the weights of provider datasets included in the batch and k is a predetermined weight (e.g., 0<k≤1) associated with the batch and/or the class/classification that encompasses the batch.

In operation 214, batches of datasets are submitted to appropriately configured computer systems. For example, in the environment of FIG. 1, each cluster 146 includes one or more physical or virtual computers configured with Apache Spark™ for processing large amounts of data.

Loads may be balanced among the clusters. For example, within each classification, the batches of datasets may be allocated to the clusters as equally as possible, such that every cluster receives the same number from that class, plus or minus one. Work may be submitted to the clusters in any order. For example, scheduling may proceed in order from the largest classification (e.g., XXL) to the smallest (e.g., XXS), so that all the XXL workflows are submitted first, followed by XL, and so on, or the workflows may be scheduled in the reverse order or in some other order.

Resources allocated to clusters (e.g., numbers of cores, executors, data storage partitions, memory) may vary depending on the data transformation workflows submitted to the clusters. For example, when the data transformation process is expected to be resource-intensive or take a longer period of time (e.g., for batches of datasets of the largest size), more resources may be allocated or dedicated than when the transformation process is expected to be less resource-intensive or require less time (e.g., batches of datasets of the smallest size).

In some embodiments, the coordinator learns each cluster's allocation of resources, and therefore can determine its processing capacity (e.g., in terms of throughput). Because it assembled the data transformation workflows, it also knows the resource requirements of the various batches of datasets to be transformed. Using this information, the coordinator strives to maximize efficiency by keeping each cluster loaded such that it employs as close to 100% of its capacity as possible.

Further, when large numbers of providers' datasets are being processed, some workflows will be queued while others are executing on the computing clusters. The coordinator may look ahead in the queue to determine whether the existing clusters will be able to service all workflows within the applicable time constraint(s). If not, one or more additional clusters may be requested or requisitioned. On the other hand, if the queued workflows do not require all clusters (i.e., they can be processed within their time constraints with fewer clusters), in order to conserve resources a cluster may be released or disbanded when its present workflow finishes.

In operation 216, transformed data are delivered to the providers or otherwise made available for viewing, reporting, querying, and so on. In some embodiments, the organization that hosts the application offers a particular visualization tool or application that providers may use to access their transformed data. The method then ends.

Although size-related labels (e.g., XXS through XXL) are used to classify providers and/or their data transformation workflows in some embodiments, in other embodiments other types of labels may be used. For example, simple alphabetical or numerical labels (e.g., A through F, 1 through 10), labels that reflect time estimates (e.g., how long it is expected to take for the corresponding datasets to be transformed), or some other labels may be used.

Advantageously, by intelligently classifying providers' data, batching workflows of like classification together evenly or almost evenly, and balancing workflows among available computing clusters, the organization that hosts the applications and performs the data transformation can limit the number of ETL pipelines that must be executed and reduce the number of clusters to the minimum number needed to transform all providers' data within applicable time constraints. This reduces the number of computing resources (e.g., data storage devices, cores (CPUs), memory, communication bandwidth) that must be reserved for the periodic data processing, and will reduce the amount of resources that will be used or consumed every time the workflows must be executed. In contrast, performing transformations on a large number of providers' data in a random or arbitrary order would likely consume many more resources, make it difficult to accurately determine how many resources should be reserved or allocated (and therefore leave resources idle and lead to inefficiency) and, in addition, might often cause data transformation workflows to fail to complete in a timely manner.

In some embodiments, data transformation workflows are scheduled for execution based on dependencies among the applications whose data are being transformed. In particular, the organization hosting the applications may maintain a directed acyclic graph (or DAG) or other guide that identifies dependencies among the applications; these dependencies apply to all providers' application data. For example, in an illustrative computing environment in which the hosted applications support providers that vend goods and/or services, data extracted from top-level applications such as Brands, Users, and Tickets (e.g., customer support tickets) may be processed in parallel because there are no dependencies among these applications.

However, only after data from the Users application are transformed (and loaded) can data from mid-level applications such as Agents and UserCustomFields be processed (which can occur in parallel). Likewise, only after data from the Tickets application are transformed (and loaded) can data from mid-level applications such as TicketsEvents and TicketsCustomFields be processed (e.g., in parallel). All mid-level applications' data therefore can be transformed in parallel, but only after the data from their corresponding top-level applications are processed.

The DAG may also include one or more additional levels, such as a bottom-level TicketsTicketUpdates application that is dependent upon the TicketsEvents application. Moreover, a given application may yield multiple datasets for each provider (e.g., from different data structures). The byte sizes of each application's set of data extracted for a given provider are combined and used to generate a weight indicating how long transformation of the application's data are expected to take (e.g., in minutes).

For example, the exemplary top-level applications listed above may be assigned the following illustrative weights based on the amount of data extracted from them for a given provider: Brands (5), Users (10), and Tickets (10). Illustrative weights for the exemplary mid-level applications may be: Agents (6), UserCustomFields (12), TicketsEvents (20), and TicketsCustomFields (15). Exemplary bottom-level application TicketsTicketUpdates may be assigned an illustrative weight of 25.

To estimate the amount of time it will take to complete a data transformation workflow that consists of these exemplary applications and illustrative weights, initially the highest weight among the three top-level applications is identified (i.e., 10) because all of them can run in parallel. The four mid-level applications can also run in parallel, and so only the highest weight among them (i.e., 20) need be identified. Finally, the sole bottom-level application has a weight of 25. Thus, because the three different tiers or levels of applications run in sequence, the final estimate for execution of the workflow is 55 minutes (i.e., 10+20+25). If the bottom-level application TicketsTicketUpdates depended upon a mid-level application that has a weight lower than the maximum of the mid-level applications (e.g., 15 instead of 20), the difference of 5 (i.e., 20-15) could be subtracted from the estimate because the bottom-level application's data likely could begin transformation before all of the mid-level applications' data are transformed.

FIG. 3 is a flow chart illustrating a method of classifying sets of data to be processed in time-constrained data transformation workflows, in accordance with some embodiments. One or more of the operations may be omitted, repeated, and/or performed in a different order. Accordingly, the specific arrangement of steps shown in FIG. 3 should not be construed in a manner that limits the scope of the embodiments.

As described above, classifying or categorizing providers and/or their portions of an immense quantity of application data is helpful in grouping or batching their data into transformation workflows and scheduling execution of the workflows so that they finish within any applicable time constraints, while dedicating as few resources as necessary to the work. Therefore, a goal of the classification is to identify or estimate, for each provider, an amount of time that will be needed to execute a workflow for transforming the provider's periodic data. If this can be done accurately, then providers can be classified such that those whose datasets require roughly the same amount of time to transform are classified the same, can be batched together, and can be expected to complete their transformations with similar timing.

In operation 302 of the method of FIG. 3, one or more criteria to use to classify providers and/or their datasets are selected. In the illustrated method, the amount of data in the provider's dataset for a given iteration of data transformation is selected as the sole criterion (e.g., all data created or modified in the provider's context during the past hour). Thus, according to this method, providers or their datasets may be classified or reclassified every time they have data to be transformed (e.g., every hour), and/or with other regularity. Because a given application may yield different amounts of data at different times for a given provider (e.g., during different 1-hour periods), that provider may regularly be classified differently.

Providers assigned to larger size-related classes may be reclassified more often than other providers. In addition, during periods of heavy end-user activity (e.g., busy shopping days for providers that sell goods), some providers may be reclassified sooner or more frequently than usual in order to ensure their data are classified correctly and are scheduled for transformation with sufficient resources to accommodate the increased data.

In other embodiments, other criteria may be selected as the basis or bases for classifying a provider. For example, some easily retrieved indicator may be used, such as a number of customers the provider has, the number of end users that connected to an application or service in the provider's context, the number of customer support (or help) tickets received from the provider's customers, etc. Or, the system may simply use the amount of time needed to process the provider's data during the last data transformation workflow for the provider. The latter scheme may suffer from frequent variance and inaccuracy and may frustrate attempts to complete all workflows within a predetermined period of time. However, when a new provider is onboarded and has not yet been classified, it may be temporarily classified the same as a similar provider (e.g., an existing provider that experiences similar user activity, subscribes to the same applications or a similar mix of applications, yields datasets of similar sizes).

In operation 304, because the selected criterion is the amount of application data a provider has accumulated since the last data transformation workflow was executed, the amount of application data that now needs to be processed is determined through estimation or summation of the amounts of data extracted or retrieved from each application on behalf of the provider. Illustratively, this may be accomplished during operation 206 of the method of FIG. 2.

In particular, while the coordinator or some other entity collects or extracts application data, it may keep a running total of the amount that was collected, or calculate an exact or approximate sum after it is all collected. At the end of operation 304, the system has an estimate or calculation of the amount of data to be processed for each provider, or at least for each provider for whom recent raw data are to be transformed.

In operation 306, the system retrieves a mapping of data amounts or sizes to classifications or labels. When size-related labels are employed (e.g., XXS to XXL), for example, the mapping described above may be employed.

In operation 308, the system applies the mappings to classify all providers whose data are to be transformed, and saves the classifications for possible reuse. The method then ends.

It may be noted that, in different operating environments, different criteria (e.g., amounts of data, number of customers) may correlate better (or worse) with the duration of time actually needed to transform providers' data. Thus, if the success of schemes described herein for processing data transformation workflows within specified time periods decreases over time, the selected criteria may be changed accordingly, the mapping of data sizes to classification labels may be adjusted, or some other change may be made.

In some embodiments, historical data are retained for extended periods of time and may be used to train a model for classifying providers, selecting criteria that correlate well with data transformation times, estimating how long it will take to transform a given provider's dataset, etc.

By configuring privacy controls or settings as they desire, providers, end users, or members of a user community that may use or interact with embodiments described herein may be able to control or restrict the information collected from them, the information that is provided to them, their interactions with such information and with other providers/users/members, and/or how such information is used. Implementation of an embodiment described herein is not intended to supersede or interfere with the privacy settings.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method, comprising:
executing multiple applications accessed by users within contexts corresponding to multiple different providers; and
on a periodic basis:
extracting from the multiple applications datasets associated with the multiple providers;
classifying each of the multiple providers into one of multiple classes;
batching datasets of providers of the same class into one or more batches; and
submitting batched datasets to a plurality of computing clusters in a balanced manner to promote transformation of the providers' extracted data within an applicable time constraint;
wherein each computing cluster transforms the batched datasets into final data for consumption by the providers.

2. The method of claim 1, wherein said classifying comprises, for each of the multiple providers:
determining a persistent classification for the provider by:
calculating or estimating an amount of data in the provider's dataset; and
assigning the provider to a predetermined class that corresponds to a range of data amounts that includes the determined amount of data.

3. The method of claim 2, wherein said classifying further comprises:
saving the assigned classifications for one or more providers; and
during a later period, reusing the saved assigned classifications instead of again determining a persistent classification for the one or more providers.

4. The method of claim 1, wherein said extracting comprises:
for each application and for each provider, retrieving from one or more data structures used by the application data associated with the provider.

5. The method of claim 1, wherein batching datasets comprises:
for each class, identifying a predetermined maximum number of datasets that, when batched, will likely be transformed by a computing cluster within the time constraint; and
grouping up to the maximum number of datasets into each of one or more batches corresponding to the class.

6. The method of claim 5, further comprising:
when multiple datasets within a first class and batched within a single batch fail to complete the transformation within the time constraint, reducing the predetermined maximum number for the first class; and
when multiple datasets within a second class and batched within a single batch fail repeatedly complete the transformation within the time constraint, increasing the predetermined maximum number for the second class.

7. The method of claim 1, wherein batching datasets comprises, within each class:
sorting all datasets classified within the class to yield a sorted list of datasets; and
for each of one or more batches, assigning the sorted datasets in a balance manner.

8. The method of claim 7, wherein assigning the sorted datasets in a balance manner comprises:
alternatingly assigning, to a given batch, sorted datasets from each end of the sorted list;
wherein said sorting comprises sorting the datasets according to corresponding weights.

9. The method of claim 1, wherein said submitting batched data sets comprises, for each of the multiple classes:
distributing approximately equal numbers of batched datasets to each of the computing clusters.

10. The method of claim 1, further comprising:
identifying, over the periodic basis, a provider whose datasets consistently fail to complete the transformation within the time constraint; and
re-classifying the provider.

11. The method of claim 1, further comprising:
selecting a characteristic of the multiple providers' datasets during a historical period;
attempting to correlate the selected characteristic with durations of time required to transform the multiple providers' datasets during the historical period;
when the selected characteristic fails to correlate with the durations of times required to transform the multiple providers' datasets, selecting a different characteristic of the multiple providers' datasets during the historical period and re-attempting to correlate the selected characteristic with the durations of times required to transform the multiple providers' datasets; and
when the selected characteristic correlates with the durations of times required to transform the multiple providers' datasets, adopting the first characteristic for use in future periods for classifying the multiple providers.

12. A non-transitory computer-readable medium storing instructions that, when executed by a processor, cause the processor to perform a method of balancing time-constrained data transformation workflows, wherein the method comprises:
executing multiple applications accessed by users within contexts corresponding to multiple different providers; and
on a periodic basis:
extracting from the multiple applications datasets associated with the multiple providers;
classifying each of the multiple providers into one of multiple classes;
batching datasets of providers of the same class into one or more batches; and
submitting batched datasets to a plurality of computing clusters in a balanced manner to promote transformation of the providers' extracted data within an applicable time constraint;
wherein each computing cluster transforms the batched datasets into final data for consumption by the providers.

13. The non-transitory computer-readable medium of claim 12, wherein said classifying comprises, for each of the multiple providers:
determining a persistent classification for the provider by:
calculating or estimating an amount of data in the provider's dataset; and
assigning the provider to a predetermined class that corresponds to a range of data amounts that includes the determined amount of data.

14. The non-transitory computer-readable medium of claim 12, wherein batching datasets comprises:
for each class, identifying a predetermined maximum number of datasets that, when batched, will likely be transformed by a computing cluster within the time constraint; and
grouping up to the maximum number of datasets into each of one or more batches corresponding to the class.

15. The non-transitory computer-readable medium of claim 12, wherein batching datasets comprises, within each class:
sorting all datasets classified within the class to yield a sorted list of datasets; and
for each of one or more batches, assigning the sorted datasets in a balance manner.

16. The non-transitory computer-readable medium of claim 12, wherein the method further comprises:
when multiple datasets within a first class and batched within a single batch fail to complete the transformation within the time constraint, reducing the predetermined maximum number for the first class; and
when multiple datasets within a second class and batched within a single batch fail repeatedly complete the transformation within the time constraint, increasing the predetermined maximum number for the second class.

17. A system for balancing time-constrained data transformation workflows, comprising:
a plurality of computing devices executing multiple applications accessed by users within contexts corresponding to multiple providers;
a coordinator comprising one or more processors and memory storing instructions that, when executed by the one or more processors, cause the coordinator to, on a periodic basis:
extract from the multiple applications datasets associated with the multiple providers;
classify each of the multiple providers into one of multiple classes;
batch datasets of providers of the same class into one or more batches; and
submit batched datasets to a plurality of computing clusters in a balanced manner to promote transformation of the providers' extracted data within an applicable time constraint; and
the plurality of computing clusters, wherein each computing cluster:
receives one or more batched datasets; and
within each batch, transforms each dataset into final data for consumption by the providers.

18. The system of claim 17, wherein said classifying comprises, for each of the multiple providers:
determining a persistent classification for the provider by:
calculating or estimating an amount of data in the provider's dataset; and
assigning the provider to a predetermined class that corresponds to a range of data amounts that includes the determined amount of data.

19. The system of claim 18, wherein said classifying further comprises:
saving the assigned classifications for one or more providers; and
during a later period, reusing the saved assigned classifications instead of again determining a persistent classification for the one or more providers.

20. The system of claim 17, wherein said extracting comprises:
for each application and for each provider, retrieving from one or more data structures used by the application data associated with the provider.

21. The system of claim 17, wherein batching datasets comprises:
for each class, identifying a predetermined maximum number of datasets that, when batched, will likely be transformed by a computing cluster within the time constraint; and
grouping up to the maximum number of datasets into each of one or more batches corresponding to the class.

22. The system of claim 21, wherein the coordinator memory further stores instructions that, when executed by the one or more processors, cause the coordinator to:
when multiple datasets within a first class and batched within a single batch fail to complete the transformation within the time constraint, reduce the predetermined maximum number for the first class; and
when multiple datasets within a second class and batched within a single batch fail repeatedly complete the transformation within the time constraint, increase the predetermined maximum number for the second class.

23. The system of claim 17, wherein batching datasets comprises, within each class:
sorting all datasets classified within the class to yield a sorted list of datasets; and
for each of one or more batches, assigning the sorted datasets in a balance manner.

24. The system of claim 17, further comprising:
selecting a characteristic of the multiple providers' datasets during a historical period;
attempting to correlate the selected characteristic with durations of time required to transform the multiple providers' datasets during the historical period;
when the selected characteristic fails to correlate with the durations of times required to transform the multiple providers' datasets, selecting a different characteristic of the multiple providers' datasets during the historical period and re-attempting to correlate the selected characteristic with the durations of times required to transform the multiple providers' datasets; and
when the selected characteristic correlates with the durations of times required to transform the multiple providers' datasets, adopting the first characteristic for use in future periods for classifying the multiple providers.
